(19) United States
(12) Patent Application Publication
(10) Pub. No.: US 2008/0074815 A1
(43) Pub. Date: Mar. 27, 2008

(54) ELECTROSTATIC DISCHARGE PROTECTION CIRCUIT

(75) Inventor: Yen-Hui Wang, Hsincu City (TW)

Correspondence Address: J C PATENTS, INC., 4 VENTURE, SUITE 250, IRVINE, CA, 92618, US

(73) Assignee: Wisepal Technologies, Inc., Miao-Li County (TW)

(21) Appl. No.: 11/551,952

(22) Filed: Oct. 23, 2006

(30) Foreign Application Priority Data
Sep. 27, 2006 (TW) 95135746

(51) Int. Cl. H02H 9/00

(52) U.S. Cl. 361/56

(57) ABSTRACT

An electrostatic discharge (ESD) protection circuit is provided. The circuit includes at least one fuse cell and a metal oxide semiconductor field effect transistor (MOSFET). Each of the fuse cells includes a fuse and outputs a bit data according to whether the fuse is melted or not. The MOSFET has a first terminal coupled to each of the fuse cells and a second terminal coupled to a voltage source. The MOSFET is for absorbing an ESD pulse so that the ESD pulse won't melt any one of the fuses.

### CROSS-REFERENCE TO RELATED APPLICATION

This application claims the priority benefit of Taiwan application serial no. 95135746, filed on Sep. 27, 2006. All disclosure of the Taiwan application is incorporated herein by reference.

### BACKGROUND OF THE INVENTION

1. Field of the Invention

The present invention relates to an electrostatic discharge (ESD) protection circuit. More particularly, the present invention relates to an ESD protection circuit applicable to one time programmable read-only memory (OTPROM).

2. Description of Related Art

Generally fuse cells are adopted for storing data in one time programmable read-only memory (OPTROM). As shown in FIG. 1, the fuse cell 101 includes a fuse 102 coupled between two voltage sources VFUSE and GFUSE. The current in the fuse 102 can be controlled through an external signal. When the current is turned on, the temperature of the fuse 102 increases so that the fuse 102 is melted. The output terminal DOUT of the fuse cell 101 outputs bit data 0 or 1 according to whether or not the fuse 102 is melted. For example, the output terminal DOUT of the fuse cell 101 outputs 1 when the fuse 102 is not melted and 0 when it is melted. Accordingly, data of the OTPROM is stored in a plurality of fuse cells, and each of the fuse cells stores a bit.

Electrostatic discharge (ESD) is a major threat to the fuse cells. When ESD occurs, high voltage pulses of up to thousands or even ten thousands volts enter the fuse cells from the voltage source. Such high voltage pulses may melt the fuses and cause data error in the fuse cells, thus, the fuse cells has to be protected from ESD.

FIG. 2 illustrates a conventional ESD protection mechanism. Wherein a protection circuit 201 is used for absorbing an ESD pulse from the voltage source VFUSE, so as to prevent the high voltage pulses from entering the fuse cell 101. The disadvantage of such method is that the protection circuit has to absorb high voltage pulses quickly, and such a circuit is very difficult to manufacture.

FIG. 3 illustrates another conventional ESD protection mechanism. Wherein a resistor 301 connected in series is used for absorbing an ESD pulse from the voltage source VFUSE, so as to prevent the high voltage pulses from entering the fuse cell 101. The disadvantage of this method is that the resistance of the resistor 301 cannot be determined. If the resistance of the resistor 301 is too low, it will be difficult to resist the ESD pulse, while if the resistance of the resistor 301 is too high, the heat for melting the fuse 102 may be diverted so that the fuse 102 cannot be melted and which may cause data error.

Accordingly, a better ESD protection mechanism is required.

### SUMMARY OF THE INVENTION

Accordingly, the present invention is directed to provide an electrostatic discharge (ESD) protection circuit which is easy to be manufactured and does not use resistor so that the disadvantages of conventional ESD protection mechanisms can be prevented.

To achieve the aforementioned and other objectives, the present invention provides an ESD protection circuit. The circuit includes a fuse cell and a first metal oxide semiconductor field effect transistor (MOSFET). The fuse cell contains a fuse and outputs a bit data according to whether or not the fuse is melted. The first MOSFET is coupled between the fuse cell and a first voltage source for absorbing an ESD pulse so that the ESD pulse would not melt the fuse.

According to an embodiment of the present invention, the first MOSFET may be an n-channel or a p-channel MOSFET. The material of the fuse in the fuse cell may be polysilicon or metal.

According an embodiment of the present invention, the fuse is coupled to the first MOSFET, and the fuse cell further includes a program switch and a read switch. The program switch is coupled between the fuse and a second voltage source, and the program switch is turned on or off according to a program signal. The read switch has a first terminal coupled between the fuse and the program switch and a second terminal coupled to the output terminal of the fuse cell, and the read switch is turned on or off according to a read signal. The read switch outputs the bit data stored in the fuse cell when the read switch is turned on.

According to an embodiment of the present invention, the voltage level of the first voltage source is higher than the voltage level of the second voltage source.

According to another aspect of the present invention, an ESD protection circuit is provided. The ESD protection circuit includes a plurality of fuse cells and a first MOSFET. Each of the fuse cells includes a fuse and outputs the bit data thereof according to whether or not the fuse is melted. The first MOSFET has a first terminal coupled to each of the fuse cells and a second terminal coupled to a first voltage source. The first MOSFET is for absorbing an ESD pulse so that the ESD pulse would not melt any one of the fuses.

As described above, in the present invention, a MOSFET is adopted for absorbing an ESD pulse in the ESD protection circuit. Since it is easy to manufacture the MOSFET and there is no need to determine the resistance of a resistor, and therefore the disadvantages in conventional techniques can be avoided.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a conventional fuse cell in a one time programmable read only memory (OTPROM).

FIGS. 2 and 3 illustrate a conventional electrostatic discharge (ESD) protection circuit for an OTPROM.

FIGS. 4 and 5 illustrate ESD protection circuits for OTPROM according to various embodiments of the present invention.

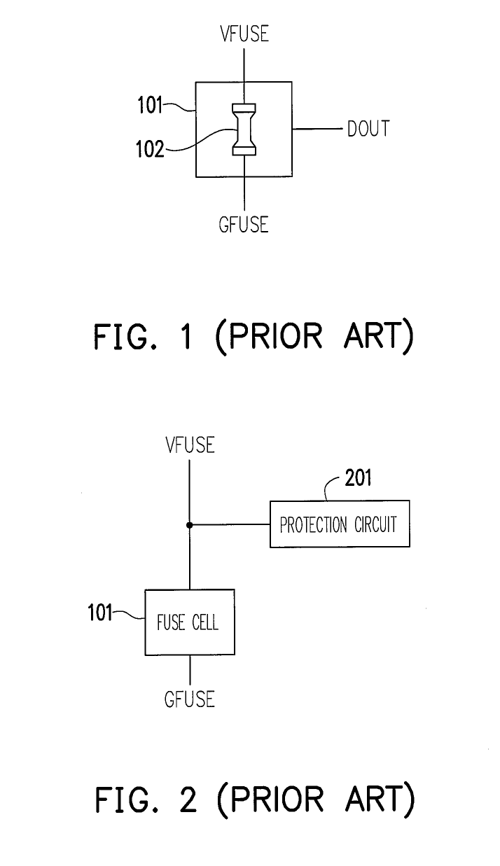

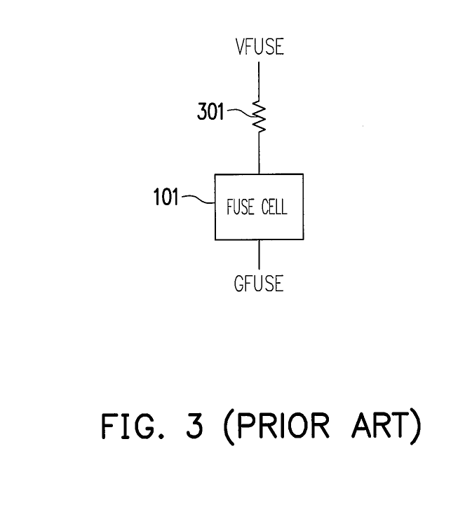

### DESCRIPTION OF EMBODIMENTS

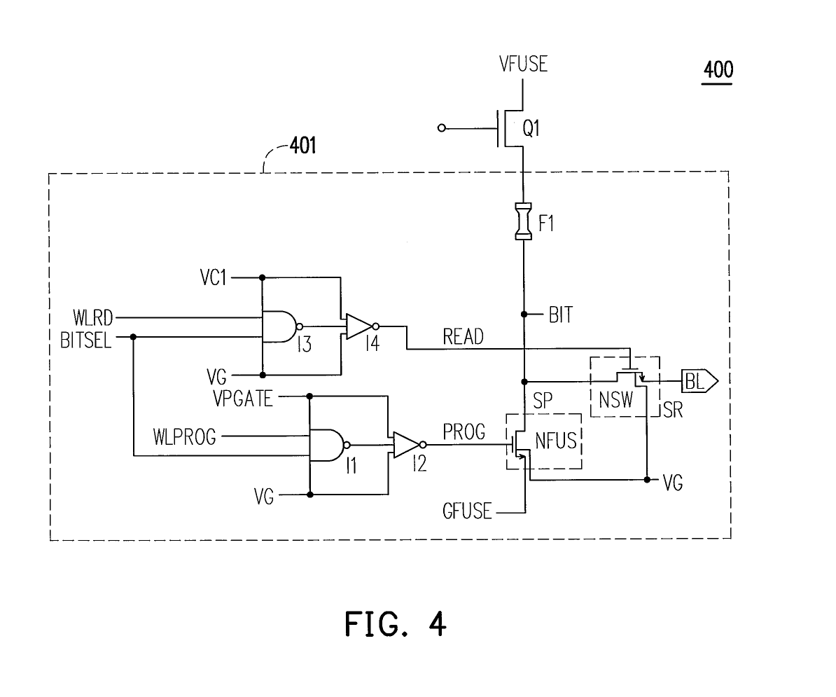

FIG. 4 illustrates an electrostatic discharge (ESD) protection circuit 400 according to an embodiment of the present invention. The ESD protection circuit 400 includes a fuse cell 401 and a metal oxide semiconductor field effect transistor (MOSFET) Q1. The fuse cell 401 contains a fuse F1 and outputs a bit data from its output terminal BL according to whether or not the fuse F1 is melted. The MOSFET Q1 is coupled between the fuse cell 401 and a voltage source VFUSE. The MOSFET Q1 is a MOSFET of large area and large size, and it is used for absorbing an ESD pulse from the voltage source VFUSE so that the ESD pulse would not melt the fuse F1. The MOSFET Q1 may be an n-channel or p-channel MOSFET.

The fuse cell 401 includes NAND gates I1 and I3, inverters I2 and I4, the fuse F1, a program switch SP, and a read switch SR. Wherein the material of the fuse F1 may be polysilicon or metal. The fuse F1 is coupled to the MOSFET Q1. The program switch is coupled between the fuse F1 and a voltage source GFUSE. The read switch SR has a first terminal coupled between the fuse F1 and the program switch SP and a second terminal coupled to the output terminal BL of the fuse cell 401. In the present embodiment, the program switch SP is implemented with a MOSFET NFUS, and the read switch SR is implemented with a MOSFET NSW.

In the present embodiment, the voltage level of the voltage source VFUSE is higher than the voltage level of the voltage source GFUSE. The program switch SP is turned on or off according to a program signal PROG. When both the MOSFET Q1 and the program switch SP are turned on, the current flowing from the voltage source VFUSE to the voltage source GFUSE causes the temperature of the fuse F1 to increase and the fuse F1 is melted.

The read switch SR is turned on or off according to a read signal READ. The read switch SR outputs the bit data stored in a junction BIT to the output terminal BL of the fuse cell 401 when the read switch SR is turned on. When the fuse F1 is not melted, the voltage source VFUSE pulls the junction BIT up to a high voltage level through the fuse F1 so that the read switch SR outputs 1. Contrarily, after the fuse F1 has been melted, the voltage source GFUSE pulls the junction BIT down to a low voltage level so that the read switch SR outputs 0.

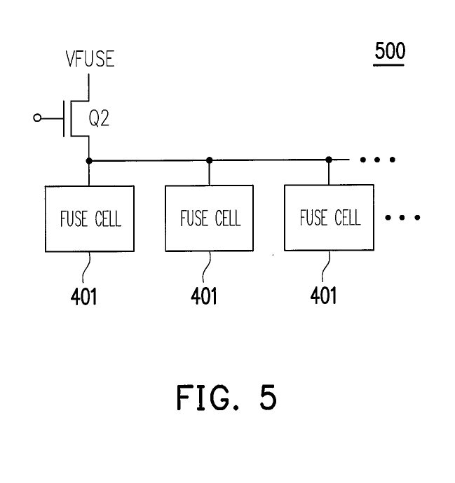

In the embodiment illustrated in FIG. 4, the MOSFET Q1 only protects a fuse cell 401. However, according to the present invention, a MOSFET may also be used for protecting a plurality of fuse cells. FIG. 5 illustrates an ESD protection circuit 500 according to another embodiment of the present invention. Wherein each fuse cell 401 has the same circuit structure and outputs its bit data according to whether or not the fuse contained therein is melted. The MOSFET Q2 has one terminal coupled to each of the fuse cells 401 and another terminal coupled to the voltage source VFUSE. Accordingly, the MOSFET Q2 can absorb an ESD pulse from the voltage source VFUSE so that the ESD pulse can be prevented from melting the fuse of any fuse cell 401.

It should be understood by those having ordinary skill in the art that the circuit design of fuse cell is not limited to the one illustrated in FIG. 4, and any conventional fuse cell circuit can also be applied in the present invention.

In summary, a MOSFET is adopted for absorbing ESD pulse in an ESD protection circuit of the present invention, and since the MOSFET is easy to manufacture and the issue of determining the resistance of a resistor does not exist in the present invention, the disadvantages in conventional techniques can be avoided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electrostatic discharge (ESD) protection circuit, comprising:
a fuse cell, comprising a fuse, for outputting a bit data according to whether or not the fuse being melted; and
a first metal oxide semiconductor field effect transistor (MOSFET), coupled between the fuse cell and a first voltage source, for absorbing an ESD pulse to prevent the ESD pulse from melting the fuse.

2. The ESD protection circuit as claimed in claim 1, wherein the first MOSFET is an n-channel MOSFET.

3. The ESD protection circuit as claimed in claim 1, wherein the first MOSFET is a p-channel MOSFET.

4. The ESD protection circuit as claimed in claim 1, wherein a material of the fuse is polysilicon.

5. The ESD protection circuit as claimed in claim 1, wherein a material of the fuse is metal.

6. The ESD protection circuit as claimed in claim 1, wherein the bit data is 0 if the fuse is melted, and the bit data is 1 if the fuse is not melted.

7. The ESD protection circuit as claimed in claim 1, wherein the fuse is coupled to the first MOSFET, and the fuse cell further comprises:
a program switch, coupled between the fuse and a second voltage source, being turned on or off according to a program signal; and
a read switch, having a first terminal coupled between the fuse and the program switch and a second terminal coupled to the output terminal of the fuse cell, being turned on or off according to a read signal, and the read switch outputting the bit data when the read switch being turned on.

8. The ESD protection circuit as claimed in claim 7, wherein the voltage level of the first voltage source is higher than the voltage level of the second voltage source.

9. The ESD protection circuit as claimed in claim 7, wherein the program switch comprises a second MOSFET.

10. The ESD protection circuit as claimed in claim 7, wherein the read switch comprises a third MOSFET.

11. An ESD protection circuit, comprising:
a plurality of fuse cells, each of the fuse cells comprising a fuse, for outputting a bit data according to whether or not the fuse being melted; and
a first MOSFET, having a first terminal coupled to the fuse cells and a second terminal coupled to a first voltage source, for absorbing an ESD pulse to prevent the ESD pulse from melting any one of the fuses.

12. The ESD protection circuit as claimed in claim 11, wherein the first MOSFET is an n-channel MOSFET.

13. The ESD protection circuit as claimed in claim 11, wherein the first MOSFET is a p-channel MOSFET.

14. The ESD protection circuit as claimed in claim 11, wherein a material of each of the fuses is polysilicon or metal.

15. The ESD protection circuit as claimed in claim 11, wherein when the fuse of one of the fuse cells is melted, the bit data output by the fuse cell is 0, and if the fuse is not melted, the bit data output by the fuse cell is 1.

16. The ESD protection circuit as claimed in claim 11, wherein the fuse of each of the fuse cells is coupled to the first MOSFET, and each of the fuse cells further comprises:
a program switch, coupled between the fuse and a second voltage source, being turned on or off according to a program signal; and
a read switch, having a first terminal coupled between the fuse and the program switch and a second terminal coupled to the output terminal of the fuse cell, being turned on or off according to a read signal, the read switch outputting the bit data when the read switch being turned on.

17. The ESD protection circuit as claimed in claim 16, wherein a voltage level of the first voltage source is higher than the voltage level of the second voltage source.

18. The ESD protection circuit as claimed in claim 16, wherein the program switch comprises a second MOSFET.

19. The ESD protection circuit as claimed in claim 16, wherein the read switch comprises a third MOSFET.
